(19) United States
(12) Patent Application Publication
(10) Pub. No.: US 2026/0042500 A1
(43) Pub. Date: Feb. 12, 2026

(54) HYBRID WHEEL-LEG ADAPTIVE SUSPENSION

(71) Applicant: The Board of Regents of University of Nebraska, Lincoln, NE (US)

(72) Inventors: Carl Nelson, Lincoln, NE (US); Nick Swerczek, Omaha, NE (US)

(21) Appl. No.: 19/294,495

(22) Filed: Aug. 8, 2025

Related U.S. Application Data
(60) Provisional application No. 63/680,695, filed on Aug. 8, 2024.

(51) Int. Cl. B62D 57/028; B60G 17/015; B64G 1/16

(52) U.S. Cl. CPC B62D 57/028; B60G 17/0152; B64G 1/16; B60G 2500/10

(57) ABSTRACT

A suspension for traversing different terrains. A suspension having adaptive stiffness behavior and multiple locomotion modes for traversing a range of different types of terrain. The suspension may include a 2-segment leg with a wheel at the end of the distal segment, collectively referred to as a wheel-leg. A motor drives the wheel relative to the leg, providing propulsion.

### RELATED APPLICATIONS

This application claims priority to U.S. Provisional Patent Application No. 63/680,695, filed Aug. 8, 2024, the entire contents of which are incorporated herein by reference.

### GOVERNMENT SUPPORT

This invention was made with government support under Grant Nos. NNX15AI09H and 80NSSC20M0112, awarded by the National Aeronautics and Space Administration. The government has certain rights in the invention.

### FIELD

The various embodiments herein relate to vehicle suspension and locomotion systems, and more particularly, to such systems for use in environments with highly variable and/or unpredictable terrain, such as, but not limited to, that which may be encountered during space travel and off-world exploration.

### BACKGROUND

With its launch of the Artemis program, NASA has expressed an increased interest in new approaches in robotic locomotion, seeking to enhance the capabilities of the robotic missions it is sending to the moon to prepare for the future human missions' arrival. For decades, NASA has relied on a rocker-bogie suspension system, as generally depicted in FIG. 1, for its off-world exploration rovers, from missions as early as the Sojourner rover to the Perseverance rover. The rocker-bogie system has proved to be a reliable and robust suspension system for wheeled movement in variable, unpredictable terrain. One disadvantage of the rocker-bogie suspension system is low speed—in Perseverance's case, less than 0.1 mph. This may limit the scope and utility of the vehicle.

There are three main categories of robotic locomotion systems for unstructured environments: wheeled, tracked, and legged. Tracked systems use belts or treads around rigid frames to generate stable motion but are often very heavy. Legged systems, by contrast, are highly dynamic systems which use serial manipulators to generate motion. They are the most adept at handling variable and unpredictable environments; however, they often require large quantities of energy to power both their joints and complex control hardware. To-date, off-world missions have utilized wheeled locomotion systems paired with entirely passive suspension systems. Wheeled movement has many advantages, including being more energy efficient than other movement types, particularly over even or controlled terrain.

Robotic locomotion systems require actuators. Traditional robotic actuators are often categorized as “stiff” and usually incorporate non-back-drivable gearboxes which allow a high degree of positional precision against any outside disturbance. However, this “stiffness” makes them undesirable in the context of more dynamic, standalone robots interacting with uncontrolled environments. In contrast, high-performance actuators used in more dynamic robotic systems often feature light, high power density motors, low-reduction, back-drivable gearboxes, and high-performance electrical hardware and software. One disadvantage of these systems is that they are incapable of storing and releasing energy as passive suspensions do, which means that the actuator must constantly consume a significant amount of electrical current, making them highly inefficient when compared to stiff actuators.

Accordingly, there is a need for a locomotion system that provides the energy-efficiency of wheeled motion without sacrificing the reconfigurability of the supporting leg and for robotic actuators for incorporation into such systems that are not stiff and yet do not consume a significant amount of electrical current.

### BRIEF SUMMARY

Described herein are various embodiments of a hybrid wheel/leg suspension/locomotion system that combines the energy efficiency benefits of wheeled motion with the ability to handle variable and unpredictable environments found in legged systems.

In Example 1, a suspension/locomotion system for a vehicle comprises an upper leg segment, a lower leg segment, wherein a distal end of the upper leg segment is pivotably coupled to a proximal end of the lower leg segment at a knee joint, a vehicle body having a mass, the vehicle body coupled to the upper leg segment near a proximal end of the upper leg segment, a wheel rotatably coupled to the lower leg segment near a distal end of the lower leg segment, the wheel configured to at least partially support the mass of the vehicle body, and a first actuation system associated with the vehicle body and operably coupled to the upper leg segment and configured to rotate the upper leg segment via the hip joint. The first actuation system comprises a first actuator and a first spring mechanically operably coupled in series with the first actuator and the upper leg segment. The suspension/locomotion system further comprises a second actuation system associated with the vehicle body and operably coupled to the lower leg segment and configured to rotate the lower leg segment via the knee joint, the second actuation system comprising a second actuator and a second spring mechanically operably coupled in series with the second actuator and the lower leg segment.

Example 2 relates to the system according to Example 1, wherein the first and second actuators are non-backdrivable actuators.

Example 3 relates to the system according to Example 1, wherein the first actuator is operably coupled to the first spring via a worm gear assembly.

Example 4 relates to the system according to Example 1, wherein the second actuation system is operably coupled to the lower leg segment via a flexible drive band and sprocket arrangement.

Example 5 relates to the system according to Example 1, wherein at least one of the first spring and the second spring comprises a torsional spring.

Example 6 relates to the system according to Example 1, further comprising a bar operably coupled with the vehicle body, wherein the hip joint and at least one of the first spring or the second spring are rotatably disposed about the body bar.

Example 7 relates to the system according to Example 1, wherein the first and second actuation systems comprise series-elastic actuation systems.

Example 8 relates to the system according to Example 1, wherein the upper leg segment and the lower leg segment are each independently positionable to adjust an overall effective suspension stiffness of the vehicle.

Example 9 relates to the system according to Example 1, wherein the wheel is configured to propel the vehicle via wheeled propulsion and the upper and lower leg segments are configured to propel the vehicle via walking propulsion.

In Example 10, a robotic vehicle comprising at least two wheel-leg suspension and locomotion systems, wherein each such system comprises a body, an upper leg segment having a proximal end pivotably coupled to the body at a hip joint and a distal end, a lower leg segment having a proximal end pivotably coupled to the distal end of the upper leg segment at a knee joint and a distal end, a wheel rotatably coupled to the distal end of the lower leg segment, and a first series-elastic actuation system associated with the body and operably coupled to the hip joint to vary an angle of the upper leg segment relative to the body. The first series-elastic actuator comprises a first actuator and a torsional spring mechanically coupled in series with the first actuator and coupled to the upper leg segment. Each system also comprises a second series-elastic actuator fixed to the body and operably coupled to the knee joint to vary an angle of the lower leg segment relative to the upper leg segment, the second series-elastic actuator comprising a non-backdrivable actuator and a torsional spring mechanically coupled in series with the non-backdrivable actuator and coupled to the lower leg segment.

Example 11 relates to the system according to Example 10, wherein the first non-backdrivable actuator is operably coupled to the first torsional spring via a worm gear assembly.

Example 12 relates to the system according to Example 10, wherein the second series-elastic actuator is operably coupled to the lower leg segment via a flexible drive band and sprocket arrangement.

Example 13 relates to the system according to Example 10, wherein at least one of the torsional springs comprises a three-spoke torsional spring.

Example 14 relates to the system according to Example 10, wherein the wheel is rotatably coupled to the distal end of the lower leg segment via a y-bracket.

Example 15 relates to the system according to Example 10, further comprising a body bar extending across the body, wherein the hip joint and at least one torsional spring are rotatably disposed about the body bar.

Example 16 relates to the system according to Example 10, wherein the upper leg segment and the lower leg segment are each independently positionable to adjust an overall effective suspension stiffness of the apparatus.

In Example 17, a method of providing suspension and locomotion for a vehicle comprises providing a vehicle body, pivotably coupling a proximal end of an upper leg segment to the vehicle body at a hip joint, pivotably coupling a proximal end of a lower leg segment to a distal end of the upper leg segment at a knee joint, rotatably coupling a wheel to a distal end of the lower leg segment, the wheel configured to at least partially support the mass of the vehicle body, actuating the upper leg segment relative to the vehicle body via a first actuation system comprising a first actuator and a first spring mechanically operably coupled in series with the first actuator and the upper leg segment, and actuating the lower leg segment relative to the upper leg segment via a second actuation system comprising a second actuator and a second spring mechanically operably coupled in series with the second actuator and the lower leg segment.

Example 18 relates to the system according to Example 17, further comprising transporting the vehicle over uneven terrain by operating a drive motor to rotate the wheel and propel the vehicle.

Example 19 relates to the system according to Example 17, further comprising transporting the vehicle over uneven terrain by, for each of at least two wheel-legs, operating an upper leg segment actuator and a lower leg segment actuator to cause the at least two wheel-legs to walk and thereby provide propulsion for the vehicle.

Example 20 relates to the system according to Example 17, further comprising selectively transporting the vehicle over uneven terrain by either operating a drive motor to rotate the wheel and propel the vehicle, or, for each of at least two wheel-legs, operating an upper leg segment actuator and a lower leg segment actuator to cause the at least two wheel-legs to walk and thereby provide propulsion for the vehicle.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

FIG. 1 is a schematic view of a known rocker-bogie suspension system.

FIG. 2 is a schematic system skeleton view of a two degree of freedom (“DOF”) wheel-leg-suspension, according to one embodiment.

FIG. 3A is a perspective view of a wheel-leg suspension system, according to one embodiment.

FIG. 3B is an exploded perspective view of the wheel-leg suspension system of FIG. 3A, according to one embodiment.

FIG. 4A is a close-up perspective view of the frame and related components of a wheel-leg suspension system, according to one embodiment.

FIG. 4B is another close-up perspective of the frame and related components of the wheel-leg suspension system of FIG. 4A, according to one embodiment.

FIG. 5A is a close-up perspective view of the frame and upper leg of a wheel-leg suspension system, according to one embodiment.

FIG. 5B is another close-up perspective view of the frame and upper leg of the wheel-leg suspension system of FIG. 5A, according to one embodiment.

FIG. 6 is a schematic diagram of a series-elastic actuator model according to one embodiment.

FIG. 7 is a schematic diagram of a one degree of freedom (“DOF”) spring-mass suspension model.

FIG. 8 is a schematic diagram of a quasi-static model for a single sprung revolute joint under gravitational loading.

FIG. 9 is a schematic diagram of a linear spring approximation model.

FIG. 10 is a graph plotting apparent vertical stiffness as a function of settling point for one link over its range of positions.

FIG. 11 is a graphical representation of apparent stiffness over all configurations.

FIG. 12 is a perspective view of a known three-spoke torsional spring design.

FIG. 13 is a graph plotting torque as a function of elastic deformation comparing a theoretical model to test results for a wheel-leg suspension.

FIG. 14 is an image showing exemplary elements of a test stand for testing stiffness of a wheel-leg suspension according to one embodiment.

FIG. 15 is a graph plotting deflection versus time for a number of varying configurations of a wheel-leg suspension.

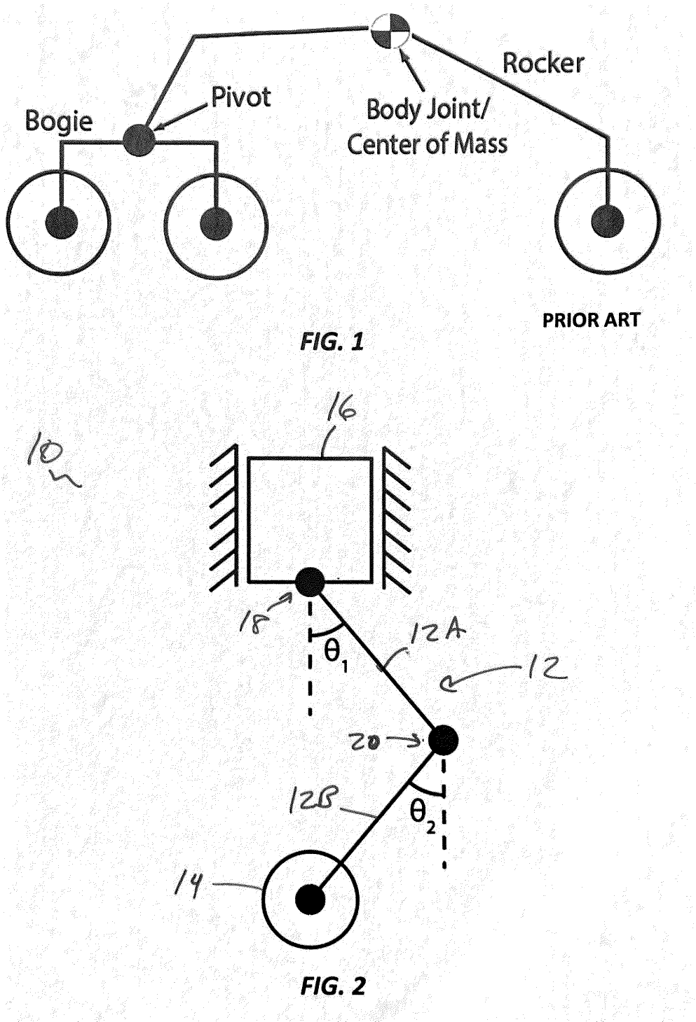

### DETAILED DESCRIPTION

Disclosed herein are various suspension/locomotion system embodiments for traversing different terrains, including a suspension having adaptive stiffness behavior, and multiple locomotion modes for traversing a range of different types of terrain. The various suspension/locomotion system implementations herein are configured to be incorporated into various types of vehicles, including robotic vehicles, for propelling such vehicles across various types of terrain. More specifically, it is envisioned that two or more—and often four or more—such suspension/locomotion systems can be incorporated into such vehicles. The adaptive suspension system may include a 2-segment leg with a wheel at the end of the distal segment, collectively referred to as a “wheel-leg” (which will also be used colloquially to refer to the various adaptive suspension embodiments disclosed and contemplated herein). A motor drives the wheel relative to the leg to provide one form of propulsion. Two other motors may operate to set or change the leg configuration (e.g., the angles of the upper and lower leg segments from vertical—at a “hip” joint and at a “knee” joint) either directly at the joints or through additional transmission elements (gears, belts, etc.). In one embodiment, a spring is placed in series with the motor driving the knee joint of the leg, and the leg configuration (e.g., the angle) along with the spring stiffness may determine the overall effective stiffness of the suspension. The chassis height may be coupled to the stiffness via the angles formed by the upper leg segment (e.g., relative to vertical) and the lower leg segment (e.g., relative to vertical).

In another embodiment, the angles at the knee joint and the knee motor are inputs to a differential such that the output of the differential is proportional to the difference between these two angles and acts against a spring-lever. An additional motor may be used to adjust the lever length (relative distances between the input and the pivot, and the pivot and the spring); this may thereby control the stiffness variation independent of the leg configuration (decoupling the chassis height from the suspension stiffness).

In any embodiment, the distal leg segment can be fitted with a passive device such as a skid plate, rollers, or a track, to enable contact with and smooth traversal over large obstacles (e.g., height exceeding the wheel diameter). The leg configuration (hip and knee angles) can also be controlled to rotate the leg in a walking mode to overcome the largest terrain obstacles.

According to certain implementations, a robotic mobility platform is provided that comprises a wheel-leg hybrid locomotion system having a 2 degree-of-freedom linkage driven by two series-elastic actuators to create a passive suspension system featuring the reconfigurability that makes legged systems advantageous. In addition, one embodiment of a method for simplifying the hybrid locomotion system's nonlinear dynamics to a model analogous to the traditional suspension system model is presented.

The wheel-leg system is a hybrid locomotion system that features a leg with a wheel attached at its lower end or “foot.” The system can possess both the energy efficiency of wheels and the dynamism and reconfigurability of legs, thereby making it viable for certain applications where available energy is limited and terrain may be varied and unpredictable, such as, for example, space exploration.

One exemplary embodiment of a hybrid suspension and locomotion system 10 is depicted schematically in FIG. 2. The system 10 has a combination of a leg 12 and a wheel 14 as shown, with the leg 12 having two leg segments 12A, 12B: a proximal (or “first” or “upper”) leg segment 12A and distal (or “second” or “lower”) leg segment 12B. The leg 12 is rotatably coupled to a body 16 at a first (or “hip”) joint 18 and the lower leg segment 12B is rotatably coupled to the upper leg segment 12A at a second (or “knee”) joint 20. The body 16 can represent the body 16 or any other component of a larger vehicle or system—including a robotic vehicle or system—to be propelled by the system 10. Thus, the system 10 has a 2 degree-of-freedom linkage (the leg 12) and a wheel 14 rotatably coupled to the distal end of the lower leg segment 12B.

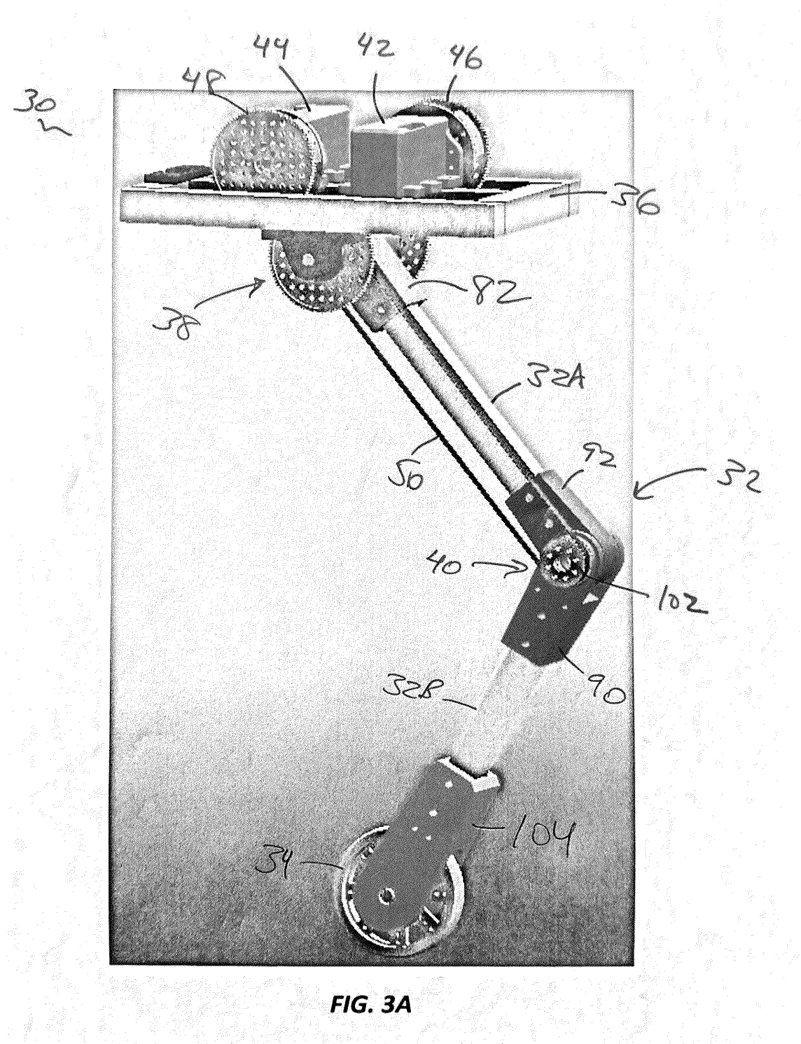

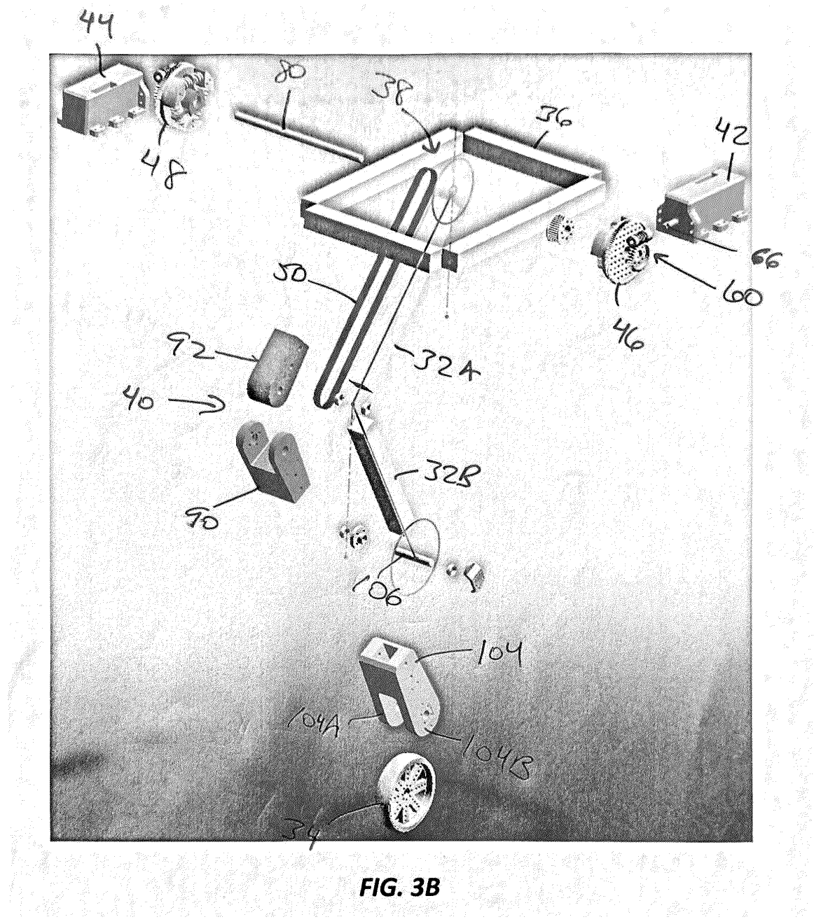

A specific implementation of another hybrid suspension and locomotion system 30 is shown in FIGS. 3A and 3B. In this embodiment, the system 30 also has a combination of a leg 32 and a wheel 34 as shown, with the leg 32 having two leg segments 32A, 32B: a proximal (or “first” or “upper”) leg segment 32A and distal (or “second” or “lower”) leg segment 32B. The leg 32 is rotatably coupled to a body 36, which, in this case, is a frame 36, at a first (or “hip”) joint 38 and the lower leg segment 32B is rotatably coupled to the upper leg segment 32A at a second (or “knee”) joint 40. The frame 36 is intended to represent the body 36 or any other component of a larger vehicle or system—including a robotic vehicle or system—to be propelled by the system 30.

The system 30 also has two actuators 42, 44 that are fixedly attached to the frame 36, with each actuator 42, 44 coupled to a torsional spring 46, 48. The first actuator 42 is coupled to the first torsional spring 46, which is operably coupled to the upper leg segment 32A such that actuation of the first actuator 42 can cause rotation of the upper leg segment 32A at the hip joint 38 via the torsional spring 46. The second actuator 44 is coupled to the second torsional spring 48, which is operably coupled to a band (or “pulley”) 50 that is operably coupled to the lower leg segment 32B such that actuation of the second actuator 44 can cause translation of the band 50 around the torsional spring 46, which causes rotation of the first lower leg segment 12B around the knee joint 40. Please also note that there is an actuator (not shown) for powering the wheel 34 to rotate and thereby move the entire system or device to which the suspension and locomotion system 30 is attached via wheeled movement, as will be described elsewhere herein.

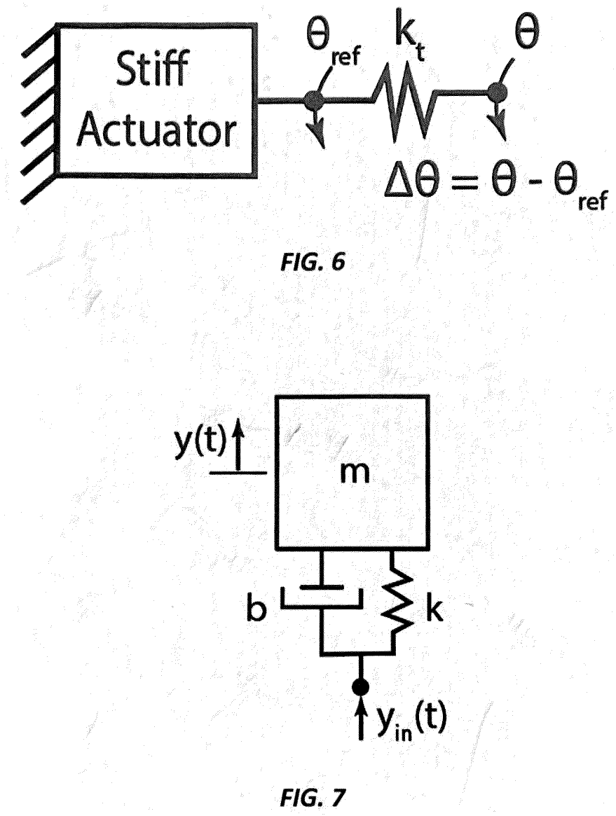

In accordance with certain embodiments, each of the actuators 42, 44 is one component of a series elastic actuator (“SEA”) 42, 44. An SEA is the combination of the actuator (such as actuator 42 or 44) and the spring (such as spring 46 or 48) in the leg 32 such that the leg 32 has two SEAs. In other words, an SEA has an inherently elastic mechanical element (such as spring 46 or 48) in series with a stiff, non-backdrivable actuator (such as actuator 42 or 44). A schematic depiction of such an arrangement is shown in FIG. 6, with θref referring to the stiff actuator's output position, kt representing a torsion spring with constant stiffness, and θ(t) being the system's overall output. By incorporating two series elastic actuators (the combinations of the first actuator 42 and first spring 46 being the first SEA and the second actuator 44 and the second spring 48 being the second SEA) into the leg 32 of the system 30, the net result is a system in which each SEA has a constant, unchangeable stiffness (in that the stiffness properties of each SEA don't change), but which still enables direct control over its position, which is determined by an equilibrium between the spring's set reference position and external loads. Further, for robotic systems that employ multiple hybrid suspension and locomotion systems (such as system 10 or 30 or any other such system as disclosed or contemplated herein), the force control and dynamic modelling of the overall robotic system can be simpler and more constrained through the use of low-cost positional encoders and feedback.

To clarify, the wheel-leg 32 with two SEAs has constant stiffness in the sense that the stiffness properties of each SEA don't change, but variable stiffness in the sense that the configuration (orientation) of the two leg segments (the upper leg segment 32A and the lower leg segment 32B) influences the effective overall stiffness behavior of the suspension. That is, a fully vertical leg 32 (at or near 90 degrees in relation to the frame 36) results in an effective overall stiffness that is very stiff, while a leg 32 with smaller angles in relation to the frame 36) results in a lesser effective overall stiffness (the smaller the angle, the less the stiffness). However, this results in a coupling between the leg configuration and the suspension stiffness (as also discussed below in the context of the torsional springs 46, 48). In other words, for each configuration of the leg 42, there is a particular stiffness. On the other hand, alternative embodiments can include the ability to further adjust stiffness properties by utilizing a differential and variable-lever as discussed in further detail below if it is desirable to both choose the leg configuration (as would be required to execute a leg trajectory in walking mode) and assign the suspension stiffness.

Thus, in addition to the independent stiffness variation at each joint 38, 40 created by the torsion springs 46, 48 and other inherent flexibility in the system 30 (and any such system herein, including system 10), the various hybrid suspension and locomotion systems (including systems 10, 30) herein can also have a varying overall stiffness based on the leg configuration, as input torques and forces into the system are only able to act on the torsion springs 46, 48 if a sufficient moment arm is available. A straighter leg configuration, for example, produces lower torques on the joints 38, 40, resulting in an apparently stiffer system.

Alternatively, the actuators 42, 44 can be any known variable-stiffness actuators (VSAs), which encompass a variety of mechanisms that have mechanically elastic elements (or other non-mechanical means) that allow the overall system (such as systems 10 or 30) to be capable of dynamically absorbing and releasing energy. Such VSAs can allow control of both a joint's position and its apparent stiffness in deviating from that position. Exemplary VSAs include, but are not limited to, rotary VSAs.

In a further alternative, the actuators 42, 44 can be any known actuators 42, 44 that feature elastic components that can allow the joint to comply with the terrain without consuming excessive energy to do so. Such actuators could—in certain implementations—allow the overall system (such as system 10 or 30) to behave similarly to traditional passive suspension systems used for wheeled locomotion.

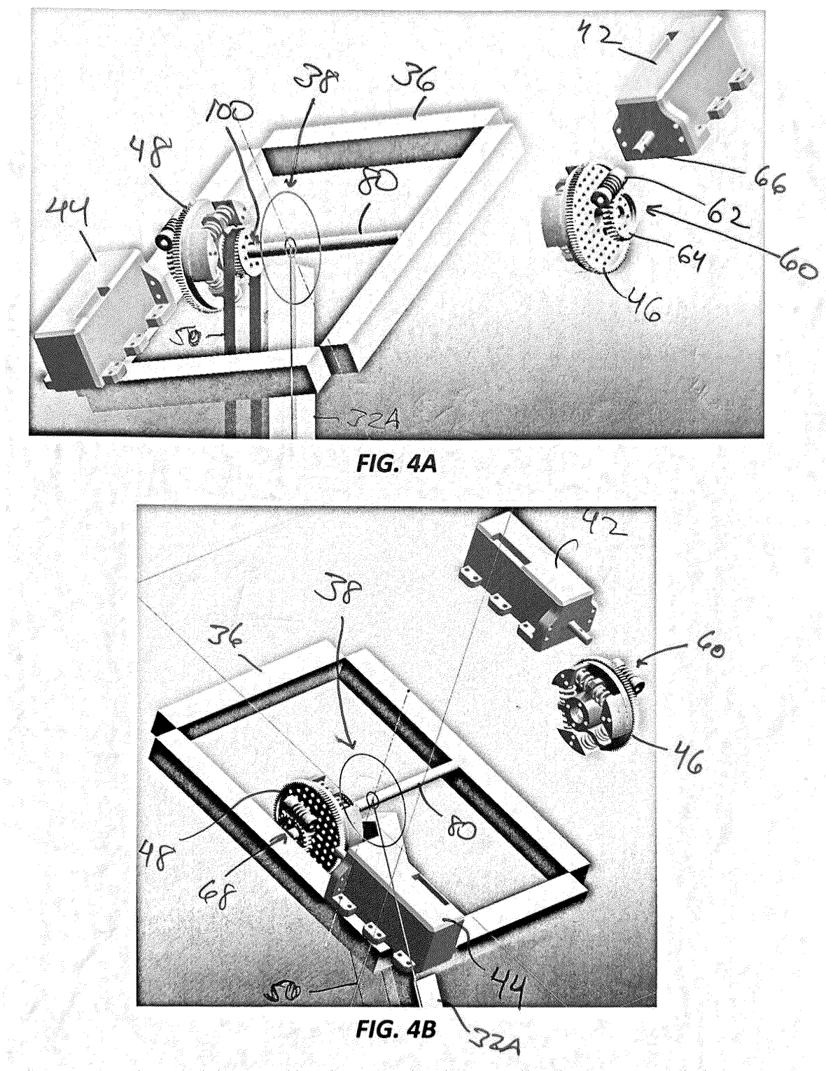

In one embodiment as best shown in FIG. 4A, the first actuator 42 can be rotatably coupled to the first torsional spring 46 (and thus the upper leg segment 32A) via a worm gear configuration 60 that is made up of a shaft with a helical thread (a “worm”) 62 that is threadably coupled to a gear with external threads (a “worm wheel”) 64 (which is coupled to the torsional spring 46). The actuator 42 has a drive shaft 66 to which the worm 62 is coupled such that actuation of the actuator 42 causes rotation of the drive shaft 66, which causes rotation of the worm shaft 62, which causes rotation of the worm wheel 64, which causes rotation of the first torsional spring 46 and thus the upper leg segment 32A. Similarly, the second actuator 44 can also be rotatably coupled to the second torsional spring 48 via a worm gear configuration 68 as best shown in FIG. 4B, with the actuator 44 and worm gear configuration 68 have the same or similar components and features as those described above with respect to the first actuator 42. Alternatively, any known arrangement of gears and/or other similar components can be used to transfer the movement from the actuators to the target components.

In one particular version, the frame 36 can have a bar (or “rod”) 80 that extends across and is coupled to opposing sides of the frame 36 as best shown in FIGS. 4A and 4B. Thus, the two torsion springs 46, 48 can be rotatably disposed on or otherwise attached to the rod 80 such that both springs 46, 48 rotate around the rod 80. As such, the rod 80 can constitute the rotational axis of the hip joint 38 as well as the rotational axis of the second torsional spring 48.

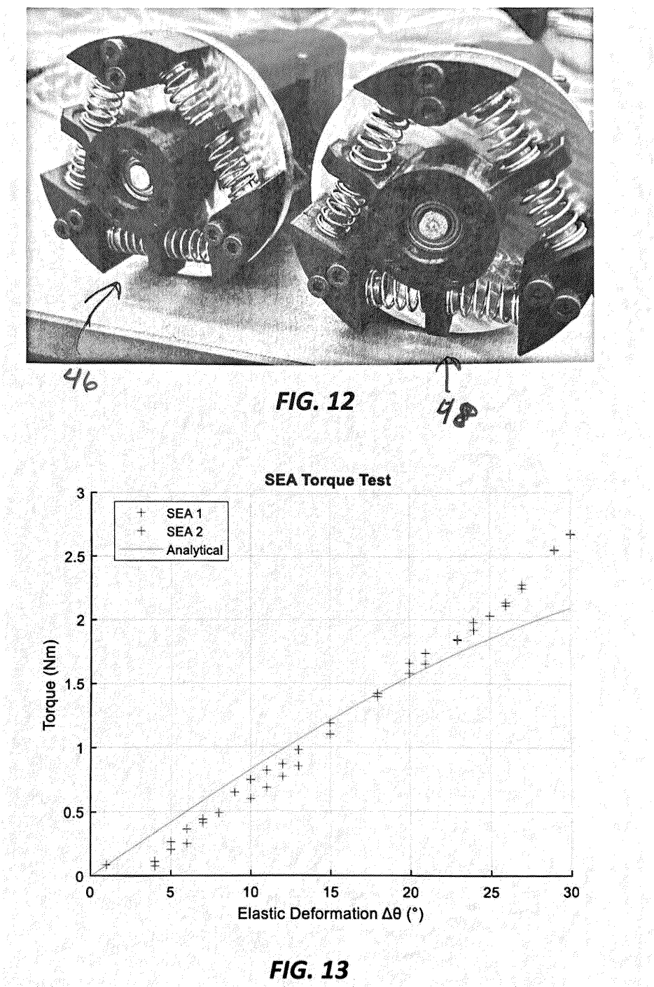

In one specific aspect, each of the torsional springs 46, 48 can be 3-spoke torsional springs 46, 48 as shown in FIG. 12. Alternatively, the torsional springs 46, 48 can be any known torsional springs, or alternatively can be other known types of springs, such as linear coil springs or the like. Each of the springs 46, 48 can be placed between the motor and the target leg segment (or “in series with the motor”) such that the spring stiffness (along with the angle of the leg segment) can help to determine the overall effective stiffness of the leg 32.

The hip joint 38, in accordance with one exemplary embodiment, can include a bracket 82 (as best shown in FIG. 3A) in which the upper leg segment 32A is disposed and attached thereto. The bracket 82 is rotatably disposed on the rod 80 and is attached to/rotationally constrained with respect to the torsion spring 46 such that rotation of the torsion spring 46 causes rotation of the bracket 82 and thus the upper leg segment 32A. Alternatively, any known mechanism, component, or structure for use in robotic joints can be used to rotatably couple the upper leg segment 32A to the frame 36.

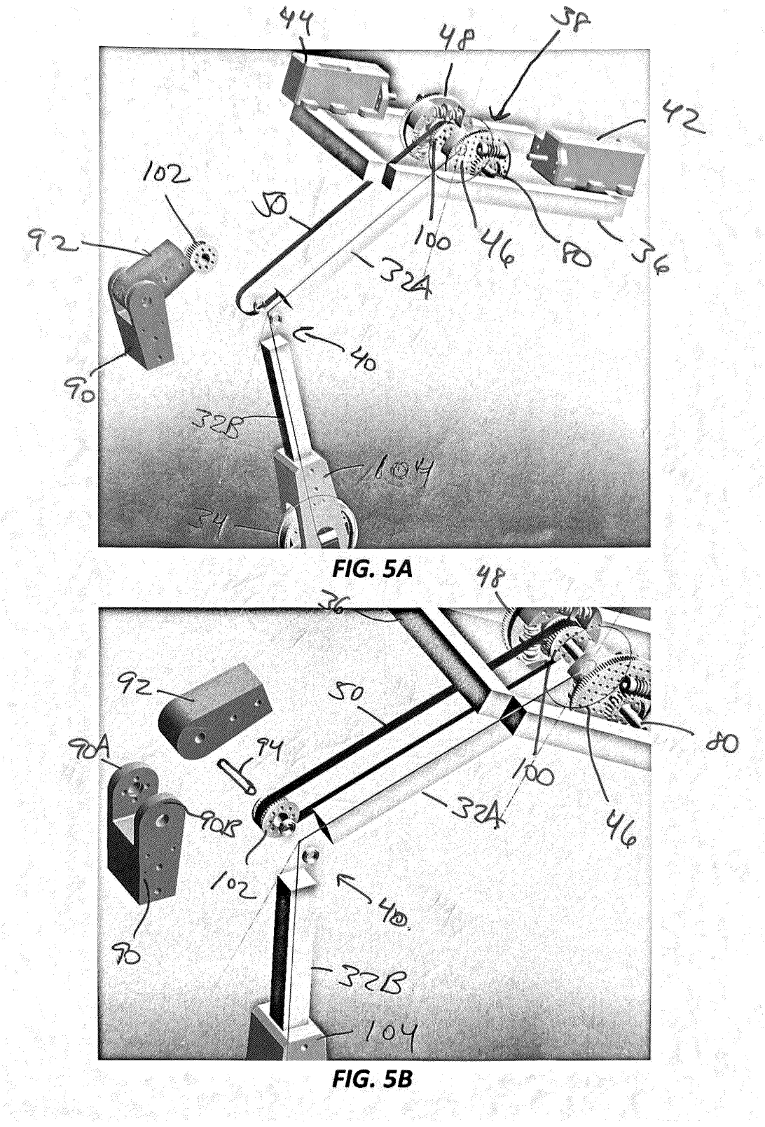

The coupling of the lower leg segment 32B to the upper leg segment 32A at the knee joint 40 will now be described in additional detail. As best shown in FIGS. 3A and 5A-B, the knee joint 40 includes a y-bracket (or “clevis”) 90 attached to the proximal end of the lower leg segment 32B and a corresponding clevis-mounted member (or “joint link”) 92 that is rotatably disposed between the two arms 90A, 90B of the clevis 90. The joint link 92 is attached to the distal end of the upper arm segment 32A and is rotatably coupled to the clevis 90 via a coupling pin 94 that is disposed through the two arms 90A, 90B and the joint link 92. Alternatively, instead of a separate y-bracket 90 attached to the lower leg segment 32B, the proximal leg segment 32B can have two arms extending therefrom to form a y-bracket 90 thereon. Similarly, instead of a separate joint link 92 attached to the upper leg segment 32B, the distal end of the upper leg segment 32B can be sized to be disposed between the two arms 90A, 90B of the clevis 90 (or through the two arms of the lower leg segment 32B) such that the distal end can be rotatably coupled to the clevis 90 (or the two arms) via a coupling pin 94. Alternatively, any known mechanism, component, or structure for use in robotic joints can be used to rotatably couple the upper leg segment 32A to the lower leg segment 32B.

The actuator 44 is operably coupled to the lower leg segment 32B via the drive band 50 to cause the rotation of the segment 32B, according to one embodiment. More specifically, the torsional spring 48 has a first or drive sprocket (or “gear”) 100 attached thereto such that the sprocket 100 is rotationally constrained to the spring 48. The proximal end of the band 50 is disposed over the sprocket 100 such that the sprocket 100 can cause the translation of the bank 50 over the sprocket via the frictional contact therebetween. Further, a second or driven sprocket (or “gear”) 102 is attached to the y-bracket 90 such that the sprocket 102 is rotationally constrained to the bracket 90. The distal end of the band 50 is disposed over the sprocket 102 such that the translation of the band 50 caused by the drive sprocket 100 can cause the rotation of the driven sprocket 102 via the frictional contact therebetween. Alternatively, the inner surface of the band 50 can have ribs or threads thereon that can be configured to mateably couple with corresponding ribs or threads on the sprockets 100, 102. Thus, actuation of the actuator 44 causes rotation of the torsional spring 48, which causes the rotation of the drive sprocket 100, which causes the translation of the band 50, which causes the rotation of the driven sprocket 102, which causes rotation of y-bracket 90 and thus the lower leg segment 32B. Alternatively, any known mechanism, component, or structure for use in robotic joints can be used to rotatably couple the upper leg segment 32A to the lower leg segment 32B.

As best shown in FIGS. 3A and 3B, the wheel 34 is rotatably coupled to the distal end of the lower leg segment 32B via a y-bracket (or “clevis”) 104 that is attached thereto. More specifically, the wheel 34 is rotatably disposed between the two arms 104A, 104B of the clevis 104 and rotatably attached thereto via a coupling pin 106. Alternatively, instead of a separate y-bracket 104 attached to the lower leg segment 32B, the distal end of the lower leg segment 32B can have two arms extending therefrom to form a y-bracket 104 thereon. Alternatively, any known mechanism, component, or structure for use in robotic joints can be used to rotatably couple the wheel 34 to the lower leg segment 32B.

As noted above, according to an alternative embodiment, the angles at the knee joint 40 and the actuator 44 coupled thereto are inputs to a differential such that the output of the differential is proportional to the difference between these two angles and acts against a spring-lever. An additional motor (not shown) can be used to adjust the lever length (relative distances between the input and the pivot, and the pivot and the spring); this may thereby control the stiffness variation independent of the leg configuration (decoupling the frame 36 height from the suspension stiffness). This configuration allows stiffness control independent of leg configuration, which can be useful particularly in legged/walking mode, as described below. As noted, the leg configuration determines the frame 36 or chassis height, which makes it possible to maintain a constant frame 36 height (resulting in a stable payload) while controlling suspension stiffness and navigating over uneven terrain.

In use, any of the systems disclosed or contemplated herein (including systems 10 and 30, for example) make it possible to simultaneously achieve dynamic stiffness control and drive various locomotion modes in a robotic system. This gives the robotic system greater locomotion capabilities and robustness compared to other robots.

More specifically, in use, the various system implementations herein provide the ability to achieve several modes of operation while controlling the effective stiffness. That is, any of the exemplary systems herein can operate in a wheel-driven mode, legged mode, or hybrid mode. It should be noted that each of these modes is described herein in the context of two or more of the exemplary wheel-leg systems being incorporated into a robotic system, device, or vehicle.

In wheel-driven mode, suitable for efficient traversal of smoother terrain, each leg (such as leg 32) is placed in a configuration to select a nominal overall stiffness, and rotation of the wheel 34 propels the robot. In this mode, the leg (such as leg 12 or leg 32) itself behaves as a passive suspension system. The leg 12, 32 is reconfigurable, with both the hip and knee joints able to be independently driven to any given position independent of one another or external interference. Thus, in the various implementations herein, the leg 12, 32 can consume a minimal amount of energy during wheeled movement while maintaining its configuration. The stiffness can also be adjusted dynamically while using this mode, by adjusting the leg configuration (or in the embodiment using a differential and spring lever, by adjusting the spring lever).

In legged mode, suitable for traversing more rugged or varied terrain, each leg 32 configuration is continuously adjusted to achieve a walking motion with intermittent contact of multiple “feet” (or wheels) with the terrain in a gait-like manner. In legged mode, the leg stiffness is important during “stance” phase, when the foot/wheel 32 is in contact with the terrain. As in the wheel-driven mode, the overall stiffness during stance phase is dependent on the leg 32 configuration (or in the embodiment using a differential and spring lever, by adjusting the spring lever).

Finally, the wheel-driven and walking modes may also be used in combination (hybrid mode). In a multi-wheel-leg robotic system, one wheel-leg may operate in one mode while another wheel-leg operates in a different mode.

### Examples

### Example 1—Wheel-Leg Dynamical Analysis

Since the leg's normal operation is to act as a passive suspension system in support of wheel-driven motion, it is worthwhile to identify the system's overall dynamic behavior. Doing so would allow it to be designed as if it were a traditional passive suspension system and could simplify the control schemes and hardware required to drive each hybrid suspension and locomotion system (or “wheel-leg”).

Passive suspension systems for wheeled vehicles are well-understood and have been thoroughly developed over the past century. This makes such a model useful when developing a system for wheeled motion. Neglecting the mass and compliance of the wheel's tire, the system supporting a single wheel may be represented as a simple vertical damped spring-mass system, as shown in FIG. 7.

The mathematical model of a system like this is a simple 2nd order differential equation with a time-varying displacement as the input. Solving this equation results in a solution which consists of simple sinusoidal motion in response to an input, with one difference to its horizontal counterpart—that the mass will be oscillating about a set offset instead of zero. This offset is the system's settling point y0, which is defined by the system's parameters. The form for the general solution for an impulse input illustrates this.

$$y ( t ) = {y}_{0} + {e}^{- at} sin ω t = \frac{mg}{k} + {e}^{- at} sin ω t \qquad ( 1 )$$

Thus, the task for determining the dynamics of the sprung wheel-leg with revolute joints becomes developing a new model which imitates the behavior and characteristics of this more traditional one. One way to approach the problem is to attempt the Lagrangian method, which if the links are assumed massless, produces a complex system of nonlinear differential equations with a 2-dimesional input. These nonlinearities are unable to be assumed away due to the system's largely rotational nature, making simulation or prediction of its behavior only practical by numerical means. An approximate plant model analogous to the traditional passive suspension system would thus greatly simplify dynamical simulation and control.

To begin developing an analytical approximation of the system's dynamics, consider first the case for a single link. By focusing only on the vertical motion of a single-link system and applying a quasi-static assumption, the following model is derived.

Here, θref is the SEA spring's reference position, or the angle at which no energy is stored in the spring. Δθ is the spring's deviation from that reference at quasi-static equilibrium, and Tk is the spring's torque resulting from this deviation. Summing the moments about the link's pivot point, the following relationship is found.

$$mgL sin ( {θ}_{ref} + Δ θ ) - {k}_{t} Δ θ = 0 \qquad ( 2 )$$

If all system parameters are known, this expression may be used to solve for the deflection Ae as a function of the independently driven variable θref. Additionally, summing these two angles together gives the equilibrium, or settling point for the joint, θs. As in the case of the vertical spring-mass system, this represents the offset point that the joint will oscillate about in response to disturbances.

$${θ}_{s} = {θ}_{ref} + Δ θ \qquad ( 3 )$$

This model furthermore may be used to approximate the rotational spring-link system as a simple vertical spring. Such an approximation moves the analysis one step closer to a comparison with the traditional spring-mass suspension system. The constraint equation (4) is used to begin this process by focusing on the differential vertical deflection of the mass caused by a rotation of the link.

$$y = L cos θ \to dy = - Ld θsinθ \qquad ( 4 )$$

Equation (4) confirms inspection since as θ approaches zero and the link becomes more vertical, more force is required to deflect the spring per unit distance. This is most apparent at the extremes of the link's angular range. When the link is horizontal (θ=90° for the purposes of this model), all differential deflection will be in the vertical direction, while conversely when the link is vertical (θ=0°), deflection causes zero vertical motion.

Secondly, a new parameter kl is introduced, which represents the apparent linear stiffness generated by the spring-link system. FIG. 9 provides a visualization of this approximation for the purposes of this derivation.

The apparent force from this fictional spring is equated to the real vertical force generated by the sprung link based on its rotary position.

$$y = L cos θ \to d y = - Ld θsinθ \qquad ( 5 )$$

Rearranging (4) and substituting the ratio of Δy/Δθ from (3) results in the following approximation for kl as a function of joint position θ.

$${k}_{l} = \frac{{k}_{t}}{{L}^{2} {sin}^{2} θ} \qquad ( 6 )$$

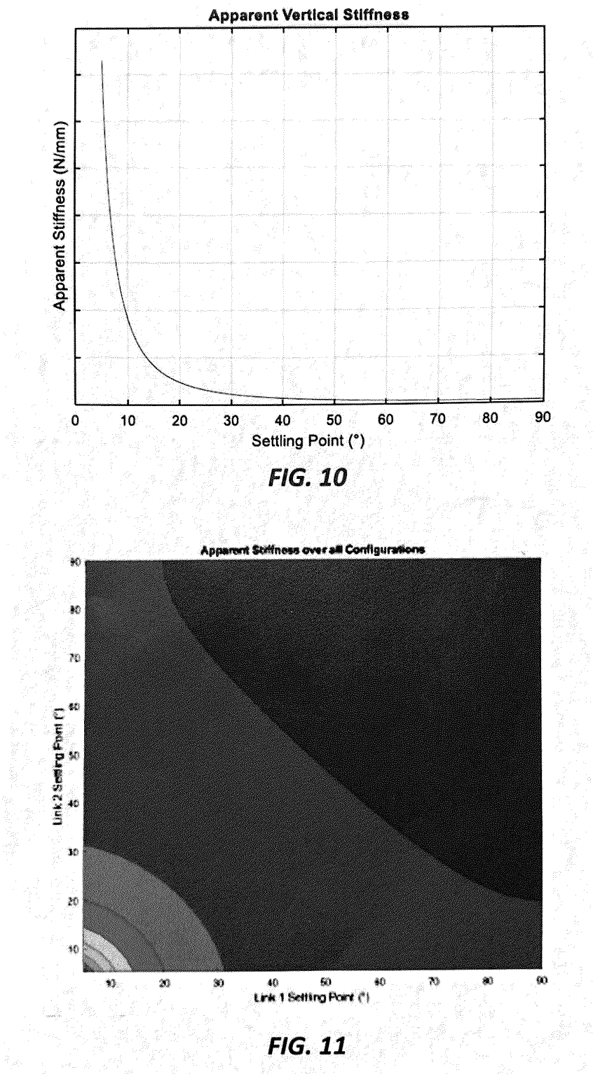

Here, k_t and L are design constants; however, θ may vary for a link depending on the system's configuration. Plotting kl over the range of available values for e provides the first insight into the wheel-leg's behavior at a given configuration. If the quasi-static assumption is continued, θ in this case becomes the joint's settling point θs. FIG. 10 shows the curve of this function plotted over the joint's available range. Numerical values have been removed from the y-axis since the curve retains its shape for any given combination of the kt and L constants.

FIG. 10 illustrates a few features of the single-link setup. The first is that as the link approaches a vertical position, stiffness increases exponentially, extending to infinity at singularity. The second is that, beyond around 30 degrees, the apparent vertical stiffness levels off and remains nearly constant for the rest of the joint's range. Between these two points, from around 10 to 30 degrees, the stiffness varies significantly and nonlinearly, beyond what could likely be usefully represented as a constant.

This approximation is useful for a variety of reasons. Firstly, when applied to the overall wheel-leg it allows a nonlinear multibody system composed of two identical sprung links to be reduced to two vertical linear springs in series. The lumped behavior of springs in series is well known to be the inverse of the sum of inverses of stiffness; performing such an operation using the approximation results in an approximate system with a single lumped stiffness and allows for some analytical predictions of behavior of the wheel-leg.

$${k}_{l , sys} = {( \frac{1}{{k}_{l , 1}} + \frac{1}{{k}_{l , 2}} )}^{- 1} = \frac{{k}_{t , 1} {k}_{t , 2}}{{k}_{t , 2} {L}_{1}^{2} {sin}^{2} {θ}_{1} + {k}_{t , 1} {L}_{2}^{2} {sin}^{2} {θ}_{2}} \qquad ( 7 )$$

Assuming that both links are identical in both length and torsional stiffness, (7) may be simplified further.

$${k}_{l , sys} = \frac{{k}_{t}}{{L}^{2} ( {sin}^{2} {θ}_{1} + {sin}^{2} {θ}_{2} )} \qquad ( 8 )$$

This result suggests an interesting property for a wheel-leg functioning in a passive suspension mode: that its lumped stiffness properties may be manipulated by simply changing its configuration. Additionally, since lumped stiffness is driven by the sum of both link angles, a single desired stiffness value could be feasibly obtained by two different configurations, or up to four different configurations when corresponding “knee-forward” or “knee-back” combinations are accounted for. This property is more plainly seen by plotting lumped system stiffness as a contour function over all available configurations.

An additional observation which may be made from FIG. 11 is that the region with near-constant apparent stiffness is achieved when either joint is in a position beyond roughly 30 degrees. Thus, a vehicle employing the wheel-leg's suspension platform could configure its legs in a combination where one of the links is at or near its singularity, relying on the other link to provide compliance with the terrain.

### Example 2—Production of Exemplary Prototype

To test and validate the theory and analysis of the wheel-leg's dynamics, a prototype according to one non-limiting embodiment was produced. While its dynamics were predicted to be complex and nonlinear, the implementation of exemplary wheel-leg was straightforward: create a leg with two links each driven by a servomotor in series with an elastic element. In some embodiments, the leg was comprised of two rigid links (e.g., an upper and a lower link or leg), each driven by a stiff servomotor in series with an elastic element.

To size the joints' hardware, some parameters were initially specified arbitrarily. The first was the length of the links, which was set for this prototype at 300 mm. The mass limit for the load was set at 5 kg. Additionally, to ensure that the prototype's dynamics resembled as closely as possible those of the model's predictions, the links were to be designed as light as possible with as little hardware mounted directly to them as possible. These parameters would affect the design of the knee joint, as a motor mounted directly to L1 would increase its mass and inertia.

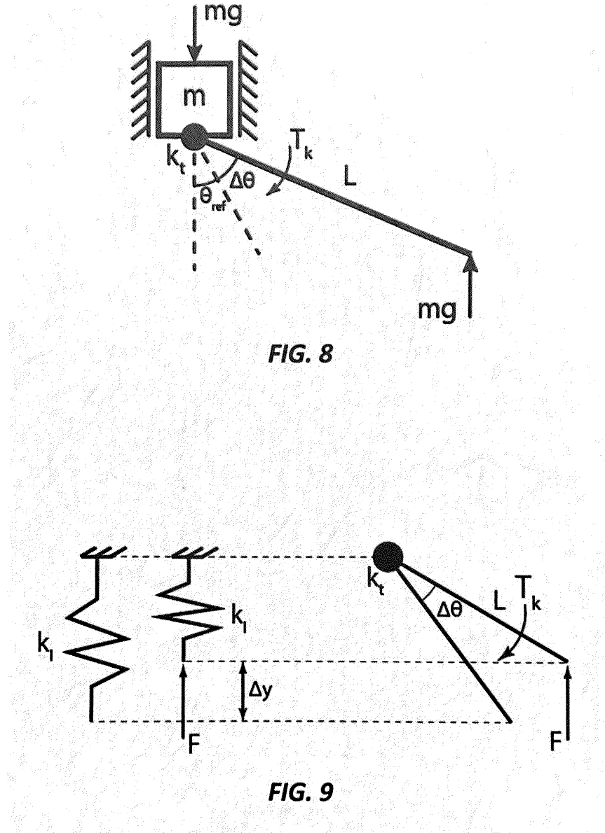

Having determined these properties, the stiffness for the joints kt could be chosen. To determine this value, the quasi-static relations defined in FIG. 8 were used to determine the maximum torques that the joints would experience. Aiming for a maximum settled deflection of 10 degrees, which would leave room for further oscillation even under maximum loading, a desired torque constant of about 1.5 Nm/° was determined.

Traditional coil torsion springs may only be deflected in one direction, but for the wheel-leg, bi-directional loading was expected, so a different method was employed. A configuration described by Tsagarakis et al. was selected, which uses linear coil springs in a radial configuration to create a high-stiffness torsional spring for use in an SEA. An example of a 3-spoke torsional spring configuration is shown in FIG. 12.

For this arrangement, equation (9) is useful as a guiding equation for design. Here, ks is the stiffness of the coil springs, R is the spoke length, and rs is the springs' external radius.

$${k}_{t} = 6 {k}_{s} ( {R}^{2} + \frac{{r}_{s}^{2}}{3} ) ( 2 {cos}^{2} Δ θ - 1 ) \qquad ( 9 )$$

For convenience in prototyping, the 3-spoke torsion spring was designed to be manufacturable by FDM 3D printing, although a machined aluminum would also suffice.

With the SEAs designed and all driving system parameters determined, the rest of the leg was developed. Aside from the links' lengths and the springs' stiffness, a few other desired characteristics drove the leg's design. The first was that the two joints were intended to be kinematically independent. Aside from the potential prototyping difficulties a coupled system could cause, coupling the movement of the two joints could potentially cause the system's dynamics to deviate from those of the model's predictions. Secondly, most of the system's mass was to be concentrated in the carriage supported by the leg. Finally, due to their rather fragile nature, the SEAs' elastic components were to experience no external loading except for the torque experienced by each corresponding link. The wheel-leg system 30 in FIG. 3 is based at least in part on some of these constraints.

In this exemplary version, the wheel-leg may be built of aluminum t-slotted extrusions and bracketing with FDM 3D-printed joints. The hip joint—and thus the primary load center—may be formed of a 10 mm aluminum axle which is fixed to the t-slotted frame by two brackets held in compression. The hardware for both joints is then mounted around the axle on ball bearings. Each SEA sits rigidly fixed atop the frame with their outputs geared into the joints' driving hardware with a 1:1 ratio. Joint 1 is driven directly in this fashion, while joint 2 is driven by a 10 mm timing belt. All motion transmission hardware was hub-mounted, and 3D-printed parts were designed to align layer lines optimally with the direction of primary loading.

### Example 3—Implementation and Model Validation

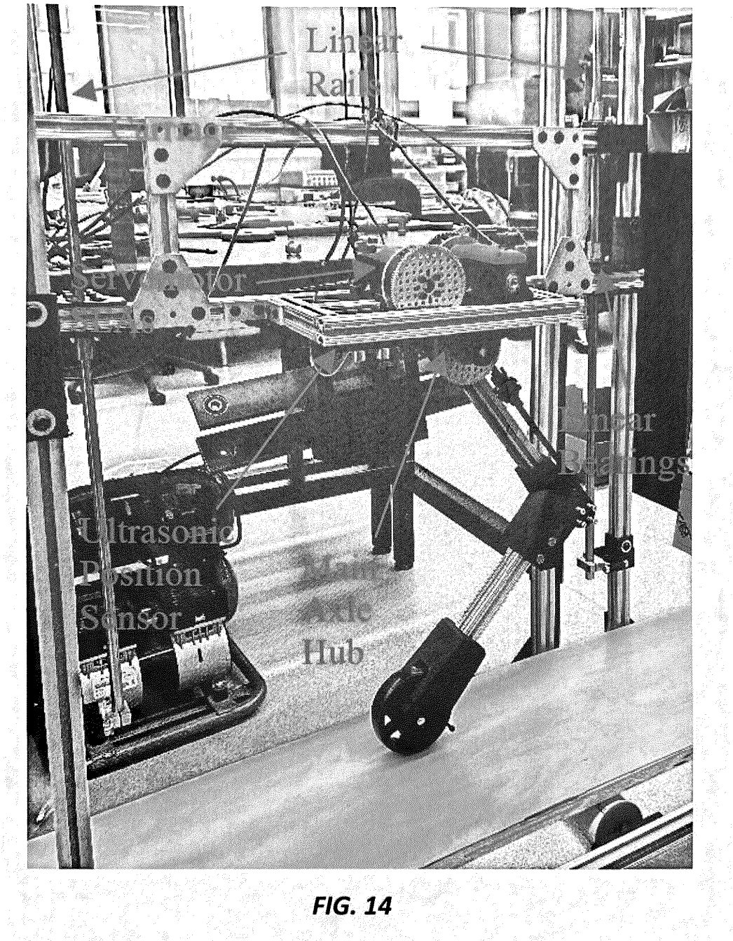

Using the configuration shown in FIG. 3, a wheel-leg prototype—according to one, non-limiting embodiment—was constructed and tested. Once constructed, the first step of this process was the stress testing and validation of the elastic sections. This was done by fixing a 150 mm moment arm to the output of each SEA and measuring the resulting force at its tip at a known radial displacement. The results of this testing are shown in FIG. 13.

The results of the torque testing follow relatively closely to the model generated by Tsagarakis et al. Most deviation from the model occurs at the extremes—near zero or maximum deformation. Near zero, this may be explained by imprecision in the measuring instruments or servo positioning, or backlash in the overall system. Conversely, at the upper extremes of deformation, the coil springs were observed to be twisting and bending significantly, which likely generated the nonlinear rise in generated torque.

A more significant observation from the torque test for the purposes of prototyping were the low torque values even at large deformations, which are less than a third of the maximum load predicted for a mass of 5 kg and link lengths of 300 mm. However, this discovery came after the rest of the leg was already built, so adjustments were made to avoid bottoming out the leg's suspension under load.

To determine the dynamics of the wheel-leg and to validate the stiffness predictions made by the analytical model, a test stand was constructed. Like the wheel-leg itself, the test stand was constructed from t-slotted framing and FDM 3D-printed parts. FIG. 14 shows a picture of the wheel-leg test stand setup.

Two vertical linear rails were fixed to the rear two columns of the frame. The wheel-leg's “carriage,” representing the constrained mass in FIG. 2, was fixed to these two rails via linear bearings mounted to 3D-printed brackets. This constrained the weight of the system to one degree of freedom—vertical translation—while allowing the leg to bear its weight and operate beneath it freely. As the SEAs' springs were too compliant to bear the full brunt of the carriage's weight without assistance, a counterweight system was added at the rear to relieve some of the gravitational load.

Both the test stand and wheel-leg were designed to be outfitted with a suite of sensors which would allow kinematic reproduction of the leg's dynamics. Both SEAs are driven by 350 kg*cm max torque servomotors controlled by PWM signals from an Arduino microcontroller. Two potentiometer knobs are used to vary the PWM signal precisely to position the joints. In addition to this, the output positions of the SEAs are read by AS5600 contactless Hall-effect rotary encoders. Coupling this with the servos' positioning enables precise tracking of the deflection and energy of the SEAs at all times. Linear positioning of both the carriage and the wheel hub is tracked by MPU6050 6-axis accelerometers: allowing direct comparison of the wheel's input motion to the carriage's output. Additionally, the position of the carriage is also tracked by an HC-SR04 ultrasonic sensor, which helps reduce integration noise from its accelerometer.

To test the stiffness of the overall system, in theory the only variable which needs to be measured is the displacement of the carriage over time. By measuring the carriage's oscillation frequency in response to an external impulse on the system, a lumped stiffness value could be surmised by the following equation, where m is the mass of the carriage.

$${k}_{l , sys} = m \sqrt{{ω}_{n}} \qquad ( 109 )$$

For the purposes of testing, it was useful to pare down the large field of configurations to two categories: symmetrical and asymmetrical configurations. Symmetrical configurations refer to configurations where the wheel is directly below the first joint, making the leg form an isosceles triangle. In such a configuration, each joint is equidistant from its vertical position, albeit in opposite directions. Asymmetrical configurations thus are defined by any set of joint values which do not fulfill these requirements. In the tests detailed in this paper, all configurations were symmetric, as this reduces the field to essentially a one-dimensional line.

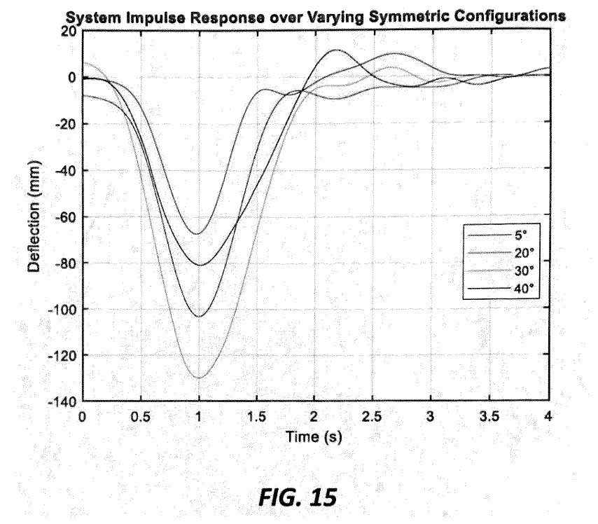

To accomplish this, of the aforementioned list of sensors, only the ultrasonic positional sensor was used in the initial test. The sensor's face was mounted to the underside of the carriage and aimed at the artificial “terrain” upon which the wheel-leg experiences wheel contact. An Arduino microcontroller was used to read the sensor's reported ultrasonic wave reflection time and record it over a serial connection into a text file. Data was recorded at a rate of 250 Hz and was smoothed in post-processing by the Gaussian method with a window of 200 samples. To excite the system, the carriage was lightly and briefly pushed in the downward direction and then released and allowed to respond. This method of excitation meant that each test did not see an identical magnitude or period of excitation, giving some variety to the resulting data. Additionally, the wheel-leg prototype was unable to bend its knee beyond about 50 degrees, as the joint's hardware acteds as a hard end-stop beyond that point. FIG. 15 shows a sampling of the results from these experiments.

Quantitative analysis of the results of these experiments was inconclusive in fully verifying the mathematical model. Due to friction within the testing rig, the carriage's response to excitation was usually slow and sluggish, and the overall system is too damped to obtain sufficiently accurate measurements to infer system stiffness (i.e., the system displays very little oscillation, which makes identification of the time of return to equilibrium nearly impossible). Despite this, both the data shown in FIG. 15 and observations made on the physical rig seem to suggest a trend of increasing stiffness as the leg approaches its singularity. In fact, in the 5° configuration test, the leg hopped a little before returning to equilibrium with very little give. Conversely, the 40° configuration can be observed returning to equilibrium more sluggishly and with more distinct oscillations than the other tests, despite the smaller amount of initial input deflection due to the knee's hard-stop. Thus, although the test did not fully verify the analytical stiffness model's predictions, the data from initial testing seems to suggest the correct trend.

Thus, the prototype testing as described above showed that the robotic mobility platform described herein provided efficient wheeled motion without maintenance power to the leg and without sacrificing the leg's reconfigurability.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount-including any integer-between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Although the various embodiments have been described with reference to preferred implementations, persons skilled in the art will recognize that changes may be made in form and detail without departing from the spirit and scope thereof.

What is claimed is:

1. A suspension/locomotion system for a vehicle, the suspension/locomotion system comprising:
a) an upper leg segment;
b) a lower leg segment, wherein a distal end of the upper leg segment is pivotably coupled to a proximal end of the lower leg segment at a knee joint;
c) a vehicle body having a mass, the vehicle body coupled to the upper leg segment near a proximal end of the upper leg segment;
d) a wheel rotatably coupled to the lower leg segment near a distal end of the lower leg segment, the wheel configured to at least partially support the mass of the vehicle body;
e) a first actuation system associated with the vehicle body and operably coupled to the upper leg segment and configured to rotate the upper leg segment via the hip joint, the first actuation system comprising:
i) a first actuator; and
ii) a first spring mechanically operably coupled in series with the first actuator and the upper leg segment; and
f) a second actuation system associated with the vehicle body and operably coupled to the lower leg segment and configured to rotate the lower leg segment via the knee joint, the second actuation system comprising:
i) a second actuator; and
ii) a second spring mechanically operably coupled in series with the second actuator and the lower leg segment.

2. The system of claim 1, wherein the first and second actuators are non-backdrivable actuators.

3. The system of claim 1, wherein the first actuator is operably coupled to the first spring via a worm gear assembly.

4. The system of claim 1, wherein the second actuation system is operably coupled to the lower leg segment via a flexible drive band and sprocket arrangement.

5. The system of claim 1, wherein at least one of the first spring and the second spring comprises a torsional spring.

6. The system of claim 1, further comprising a bar operably coupled with the vehicle body, wherein the hip joint and at least one of the first spring or the second spring are rotatably disposed about the body bar.

7. The system of claim 1, wherein the first and second actuation systems comprise series-elastic actuation systems.

8. The system of claim 1, wherein the upper leg segment and the lower leg segment are each independently positionable to adjust an overall effective suspension stiffness of the vehicle.

9. The system of claim 1, wherein the wheel is configured to propel the vehicle via wheeled propulsion and the upper and lower leg segments are configured to propel the vehicle via walking propulsion.

10. A robotic vehicle comprising at least two wheel-leg suspension and locomotion systems, each system comprising:
a) a body;
b) an upper leg segment having a proximal end pivotably coupled to the body at a hip joint and a distal end;
c) a lower leg segment having a proximal end pivotably coupled to the distal end of the upper leg segment at a knee joint and a distal end;
d) a wheel rotatably coupled to the distal end of the lower leg segment;
e) a first series-elastic actuation system associated with the body and operably coupled to the hip joint to vary an angle of the upper leg segment relative to the body, the first series-elastic actuator comprising:
i) a first actuator; and
ii) a torsional spring mechanically coupled in series with the first actuator and coupled to the upper leg segment; and
f) a second series-elastic actuator fixed to the body and operably coupled to the knee joint to vary an angle of the lower leg segment relative to the upper leg segment, the second series-elastic actuator comprising:
i) a non-backdrivable actuator; and
ii) a torsional spring mechanically coupled in series with the non-backdrivable actuator and coupled to the lower leg segment.

11. The robotic vehicle of claim 10, wherein the first non-backdrivable actuator is operably coupled to the first torsional spring via a worm gear assembly.

12. The robotic vehicle of claim 10, wherein the second series-elastic actuator is operably coupled to the lower leg segment via a flexible drive band and sprocket arrangement.

13. The robotic vehicle of claim 10, wherein at least one of the torsional springs comprises a three-spoke torsional spring.

14. The robotic vehicle of claim 10, wherein the wheel is rotatably coupled to the distal end of the lower leg segment via a y-bracket.

15. The robotic vehicle of claim 10, further comprising a body bar extending across the body, wherein the hip joint and at least one torsional spring are rotatably disposed about the body bar.

16. The robotic vehicle of claim 10, wherein the upper leg segment and the lower leg segment are each independently positionable to adjust an overall effective suspension stiffness of the apparatus.

17. A method of providing suspension and locomotion for a vehicle, the method comprising:
providing a vehicle body;
pivotably coupling a proximal end of an upper leg segment to the vehicle body at a hip joint;
pivotably coupling a proximal end of a lower leg segment to a distal end of the upper leg segment at a knee joint;
rotatably coupling a wheel to a distal end of the lower leg segment, the wheel configured to at least partially support the mass of the vehicle body;
actuating the upper leg segment relative to the vehicle body via a first actuation system comprising a first actuator and a first spring mechanically operably coupled in series with the first actuator and the upper leg segment; and
actuating the lower leg segment relative to the upper leg segment via a second actuation system comprising a second actuator and a second spring mechanically operably coupled in series with the second actuator and the lower leg segment.

18. The method of claim 17, further comprising transporting the vehicle over uneven terrain by operating a drive motor to rotate the wheel and propel the vehicle.

19. The method of claim 17, further comprising transporting the vehicle over uneven terrain by, for each of at least two wheel-legs, operating an upper leg segment actuator and a lower leg segment actuator to cause the at least two wheel-legs to walk and thereby provide propulsion for the vehicle.

20. The method of claim 17, further comprising selectively transporting the vehicle over uneven terrain by either:
operating a drive motor to rotate the wheel and propel the vehicle; or
for each of at least two wheel-legs, operating an upper leg segment actuator and a lower leg segment actuator to cause the at least two wheel-legs to walk and thereby provide propulsion for the vehicle.
